(19) United States
(12) Patent Application Publication
(10) Pub. No.: US 2026/0080042 A1
(43) Pub. Date: Mar. 19, 2026

(54) INFORMATION PROCESSING APPARATUS, AUTHENTICATION SYSTEM, AUTHENTICATION METHOD, AND NON-TRANSITORY COMPUTER READABLE MEDIUM

(71) Applicant: NEC CORPORATION, Minato-ku, Tokyo (JP)

(72) Inventors: Shuuji KIKUCHI, Tokyo (JP); Hiroyoshi SAWAI, Tokyo (JP)

(73) Assignee: NEC Corporation, Minato-ku, Tokyo (JP)

(21) Appl. No.: 19/108,465

(22) PCT Filed: Sep. 21, 2022
(86) PCT No.: PCT/JP2022/035236

§ 371 Date: Mar. 4, 2025

(51) Int. Cl. G06F 21/32; G06V 40/16

(52) U.S. Cl. CPC G06F 21/32; G06V 40/172; G06V 40/174

(57) ABSTRACT

An information processing apparatus, an authentication system, an authentication method, and a non-transitory computer readable medium are provided. An information processing apparatus includes: an authentication unit configured to control face authentication by comparing face information for authentication of a user acquired in each of a plurality of locations in a facility with face information for registration registered in advance; a smile degree calculation unit configured to calculate a smile degree of the user from the face information for authentication; a generation unit configured to accumulate the smile degrees of the user calculated from the face information for authentication acquired in the plurality of respective locations in the facility to generate a cumulative smile degree; and an output control unit configured to control output of a result of comparing the cumulative smile degree of the user and that of another user.

### TECHNICAL FIELD

The present disclosure relates to an information processing apparatus, an authentication system, an authentication method, and a non-transitory computer readable medium.

### BACKGROUND ART

Techniques for carrying out settlement and performing processing for entry to attractions in amusement facilities using face authentication have been developed. Further, it has been attempted to make amusement facilities more attractive by using face authentication techniques. For example, Patent Literature 1 discloses generating, in a case where a user in an image captured at a time of face authentication at a final location in an amusement facility is smiling, a composite image by a photo frame (template) corresponding to a smiling point indicating a degree of smiling.

### CITATION LIST

### Patent Literature [Patent Literature 1] International Patent Publication No. WO 2021/250817

### SUMMARY OF INVENTION

### Technical Problem

However, in Patent Literature 1, the smile degree is determined only at the final location in the amusement facility. Therefore, it has been required to make an amusement facility even more attractive by using a face authentication technique.

An object of the present disclosure is to provide an information processing apparatus, an authentication system, an authentication method, and a non-transitory computer readable medium capable of making an amusement facility even more attractive.

### Solution to Problem

An information processing apparatus according to a first aspect of the present disclosure includes: authentication means for controlling face authentication by comparing face information for authentication of a user acquired in each of a plurality of locations in a facility with face information for registration registered in advance; smile degree calculation means for calculating a smile degree of the user from the face information for authentication; cumulative smile degree generation means for accumulating the smile degrees of the user calculated from the face information for authentication acquired in the plurality of respective locations in the facility to generate a cumulative smile degree; and output control means for controlling output of a result of comparing the cumulative smile degree of the user and that of another user.

An authentication system according to a second aspect of the present disclosure includes: authentication terminals installed in a plurality of locations in a facility; and an information processing apparatus capable of communicating with the authentication terminals, in which the information processing apparatus includes user information registration means for registering face information for registration of a user in storage means, the authentication terminal includes authentication face information acquisition means for acquiring face information for authentication of the user, and the information processing apparatus further includes: authentication means for performing face authentication by comparing face information for authentication of the user acquired in each of the plurality of locations in the facility with the face information for registration; smile degree calculation means for calculating, in a case where the face authentication has been successful, a smile degree of the user from the face information for authentication; cumulative smile degree generation means for accumulating the smile degrees of the user calculated from the face information for authentication acquired in the plurality of respective locations in the facility to generate a cumulative smile degree; and output control means for causing the authentication terminal to output a result of comparing the cumulative smile degree of the user with that of another user.

In an authentication method according to a third aspect of the present disclosure, a computer: controls face authentication by comparing face information for authentication of a user acquired in each of a plurality of locations in a facility with face information for registration registered in advance; calculates a smile degree of the user from the face information for authentication; accumulates the smile degrees of the user calculated from the face information for authentication acquired in the plurality of respective locations in the facility to generate a cumulative smile degree; and controls output of a result of comparing the cumulative smile degree of the user with that of another user.

A non-transitory computer readable medium according to a fourth aspect of the present disclosure stores a program for causing a computer to perform: processing for controlling face authentication by comparing face information for authentication of a user acquired in each of a plurality of locations in a facility with face information for registration registered in advance; processing for calculating a smile degree of the user from the face information for authentication; processing for accumulating the smile degrees of the user calculated from the face information for authentication acquired in the plurality of respective locations in the facility to generate a cumulative smile degree; and processing for controlling output of a result of comparing the cumulative smile degree of the user with that of another user.

### Advantageous Effects of Invention

It is possible to provide an information processing apparatus, an authentication system, an authentication method, and a non-transitory computer readable medium capable of making an amusement facility even more attractive.

### BRIEF DESCRIPTION OF DRAWINGS

FIG. 1 is a block diagram showing one example of an information processing apparatus according to a first example embodiment;

FIG. 2 is a flowchart showing one example of an authentication method according to the first example embodiment;

FIG. 3 is a block diagram showing one example of an authentication system according to a second example embodiment;

FIG. 4 is a block diagram showing one example of an authentication terminal according to the second example embodiment;

FIG. 5 is a block diagram showing one example of an information processing apparatus according to the second example embodiment;

FIG. 6 is a diagram showing one example of a data structure of user information according to the second example embodiment;

FIG. 7 is a diagram showing one example of a data structure of cumulative smile degree information according to the second example embodiment;

FIG. 8 is a diagram showing one example of a data structure of touring history information according to the second example embodiment;

FIG. 9 is a diagram showing one example of a data structure of benefits granting conditions according to the second example embodiment;

FIG. 10 is a flowchart showing one example of processing for registering the user information in an authentication method according to the second example embodiment;

FIG. 11 is a flowchart showing one example of the authentication method according to the second example embodiment;

FIG. 12 is a flowchart showing one example of the authentication method according to the second example embodiment; and

FIG. 13 is a diagram showing one example of a display unit of an authentication terminal according to the second example embodiment.

### EXAMPLE EMBODIMENT

Hereinafter, with reference to the drawings, example embodiments of the present disclosure will be described.

### First Example Embodiment

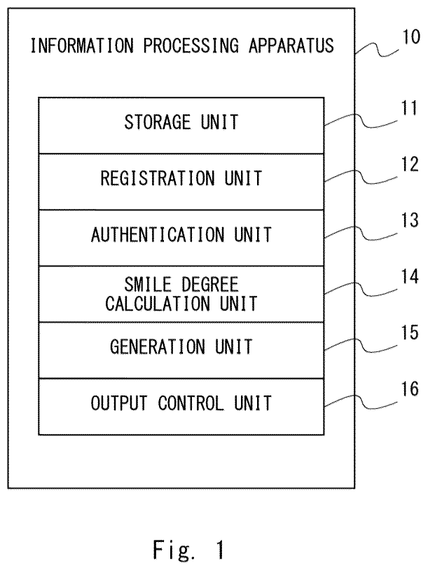

FIG. 1 is a block diagram showing one example of an information processing apparatus 10 according to a first example embodiment. The information processing apparatus 10 performs processing for authenticating a face of a user (face authentication processing) acquired in each of a plurality of locations of an amusement facility such as a theme park. The user here is a person visiting this amusement facility. The information processing apparatus 10 may communicate with authentication terminals (not shown) installed in the plurality of respective locations of the amusement facility. Further, the information processing apparatus 10 may communicate with a user terminal (not shown) that the user carries. Further, the information processing apparatus 10 may communicate with registration terminals (not shown) installed inside or outside of the amusement facility.

As shown in FIG. 1, the information processing apparatus 10 includes a storage unit 11, a registration unit 12, an authentication unit 13, a smile degree calculation unit 14, a generation unit 15, and an output control unit 16.

The storage unit 11 is also referred to as storage means. The storage unit 11 stores face information for registration.

The registration unit 12 is also referred to as user information registration means. The registration unit 12 registers user information in the storage unit 11. The user information here includes at least face information for registration of the user. The face information for registration of the user is, for example, information extracted from a face image generated by capturing an image of the user's face. Note that a face image acquired by capturing the user's face by one of the authentication terminals installed in the plurality of respective locations of the amusement facility may be transmitted from the authentication terminal to the information processing apparatus 10. Further, the information processing apparatus 10 may include a camera (not shown), and an image of the user's face may be captured by the camera, whereby the face image may be acquired. Further, the image of the user's face may be captured by a camera of the user terminal that can communicate with the information processing apparatus 10, and the face image may be input to the information processing apparatus 10 from the user terminal.

The authentication unit 13 is also referred to as authentication means. The authentication unit 13 controls face authentication by comparing face information for authentication of the user acquired by authentication terminals installed in the plurality of respective locations of the amusement facility with the face information for registration stored in the storage unit 11. Note that the biometric authentication processing may be performed in the information processing apparatus 10 or in another apparatus such as an authentication terminal (not shown).

The smile degree calculation unit 14 is also referred to as smile degree calculation means. The smile degree calculation unit 14 calculates, in a case where the face authentication has been successful, a smile degree of the user from the face information for authentication. The calculated smile degree is supplied to the generation unit 15.

The generation unit 15 is also referred to as cumulative smile degree generation means. The generation unit 15 accumulates smile degrees of the user calculated from face information for authentication acquired in the plurality of respective locations in the facility to generate a cumulative smile degree. The generated cumulative smile degree is supplied to the output control unit 16.

The output control unit 16 is also referred to as output control means. The output control unit 16 controls output of results of comparing the cumulative smile degree of the user with that of another user in the authentication terminal. Specifically, the output control unit 16 generates results of comparing the cumulative smile degree of the user with that of another user, and controls output of the authentication terminal in such a way that the comparison results are displayed.

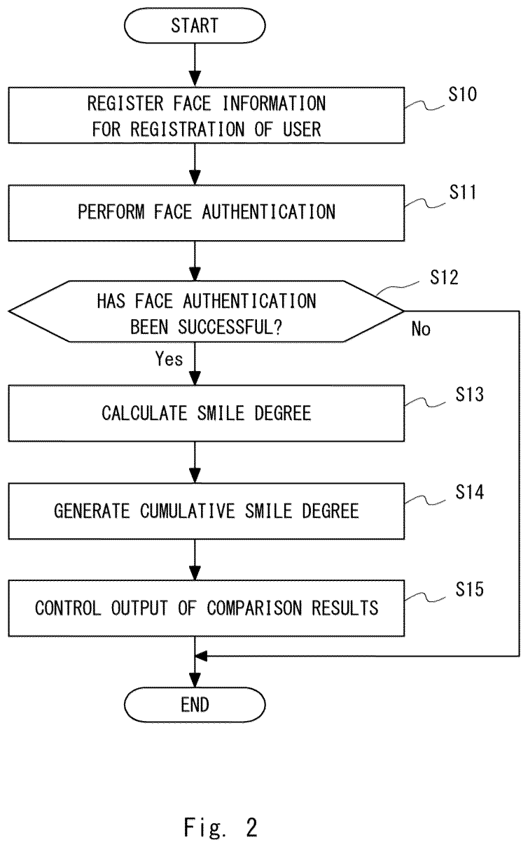

FIG. 2 is a flowchart showing an authentication method according to the first example embodiment. First, the registration unit 12 registers face information for registration of the user in the storage unit 11 (Step S10). Next, the authentication unit 13 performs, in a case where face information for authentication has been received from authentication terminals installed in the plurality of respective locations of the amusement facility, face authentication by comparing the face information for registration with the face information for authentication (Step S11). When the face authentication has not been successful (No in Step S12), this process is ended. On the other hand, in a case where the face authentication has been successful (Yes in Step S12), the smile degree calculation unit 14 calculates a smile degree of the user from the face information for authentication (Step S13). Next, the generation unit 15 generates a cumulative smile degree by accumulating the smile degree calculated in Step S13 (Step S14). Specifically, the generation unit 15 generates a cumulative smile degree by adding the smile degree calculated in Step S13 to the smile degrees accumulated before the face authentication is performed in Step S11. Next, the output control unit 16 causes the authentication terminal to output results of comparing the cumulative smile degree of the user with that of another user (Step S15), and this process is ended.

With the information processing apparatus 10 according to the first example embodiment described above, the smile degree of the user at each location is calculated from face information for authentication received from authentication terminals installed in the plurality of respective locations of the amusement facility, and a cumulative smile degree in which the calculated smile degrees are accumulated is generated. Then the authentication terminal is caused to output the results of comparing (ranking) the cumulative smile degree of the user with that of another user. Therefore, compared to a case in which a smile degree is determined only at a final location in the amusement facility, the amusement facility can be made even more attractive using the face authentication technique.

Note that the information processing apparatus 10 includes, as components that are not shown, a processor, a memory, and a storage apparatus. Further, this storage apparatus stores a computer program in which processing of a learning method according to this example embodiment is implemented. Then the processor loads a computer program into the memory from the storage apparatus to execute this computer program. Accordingly, the processor implements functions of the registration unit 12, the authentication unit 13, the smile degree calculation unit 14, the generation unit 15, and the output control unit 16.

Alternatively, each of the registration unit 12, the authentication unit 13, the smile degree calculation unit 14, the generation unit 15, and the output control unit 16 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as the processor.

### Second Example Embodiment

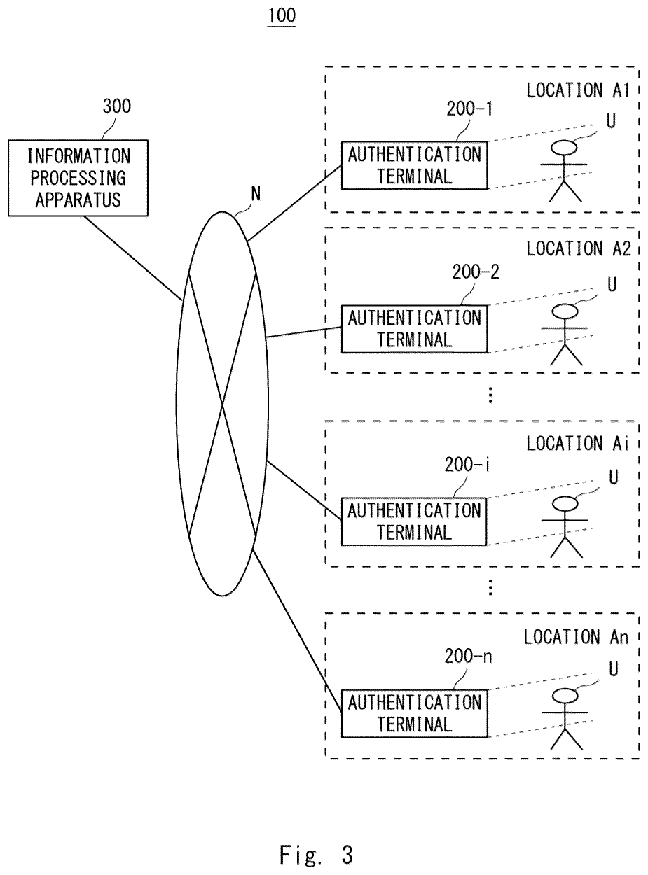

Next, an authentication system 100 according to a second example embodiment will be described. FIG. 3 is a block diagram showing an overall structure of the authentication system 100 according to the second example embodiment. The authentication system 100 is a computer system that performs biometric authentication of a user U in an amusement facility such as a theme park. Hereinafter, face authentication will be taken as an example of biometric authentication, but this is merely an example.

The authentication system 100 includes authentication terminals 200-1, 200-2, . . . 200-i, . . . 200-n (1≤i≤n, n is a positive integer) and an information processing apparatus 300. The authentication terminals 200-1, 200-2, . . . 200-i, . . . and 200-n and the information processing apparatus 300 may communicate with each other via a network N. Note that the information processing apparatus 300 may communicate with user terminals (not shown) carried by users. The information processing apparatus 300 may communicate with registration terminals (not shown) installed inside or outside of the amusement facility. Further, the authentication terminals 200-1, 200-2, . . . 200-i, . . . and 200-n may communicate with the user terminals by a predetermined mode of short-range radio communication. Further, the authentication terminals 200-1, 200-2, . . . 200-i, . . . and 200-n may communicate with the user terminals via the network N. Further, the network N is a wired or wireless communication line.

In the following description, each of the authentication terminals 200-1, 200-2, . . . 200-i, . . . and 200-n may be simply referred to as an authentication terminal(s) 200 when it is not necessary to distinguish between them. The authentication terminals 200 are, for example, digital signage installed in a plurality of respective locations of the amusement facility, i.e., a location 1, a location 2, . . . a location i, . . . and a location n.

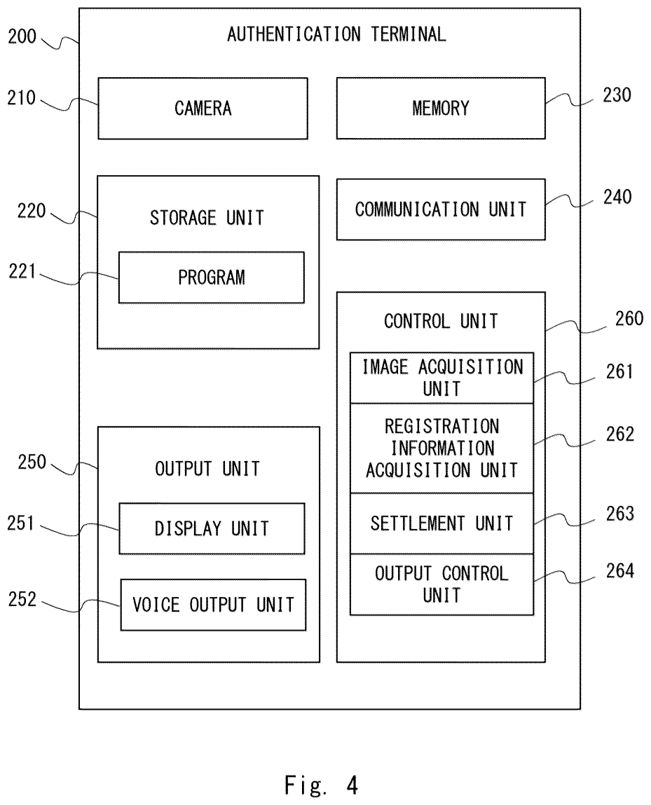

FIG. 4 is a block diagram showing one example of the authentication terminal 200. As shown in FIG. 4, the authentication terminal 200 includes a camera 210, a storage unit 220, a memory 230, a communication unit 240, an output unit 250, and a control unit 260.

The camera 210 captures images in accordance with control of the control unit 260. The camera 210 captures an image of a face of a user U in accordance with control of the control unit 260.

The storage unit 220 is a storage apparatus that stores a program 221 for implementing each function of the authentication terminal 200. The memory 230, which is a volatile storage apparatus such as a RAM, is a storage area for temporarily holding information when the control unit 260 is operated. The communication unit 240 is a communication interface with the network N.

The output unit 250 outputs results of information processing in the control unit 260. The output unit 250 includes, for example, a display unit 251 and a voice output unit 252. The display unit 251 is a display apparatus that displays the results of information processing in the control unit 260. Note that the authentication terminal 200 may include an input unit (not shown) that receives input, and the display unit 251 and the input unit may be integrally configured like, for example, a touch panel. The voice output unit 252, which includes a speaker (not shown), outputs the results of information processing in the control unit 260 by voice.

The control unit 260 is a processor that controls each component of the authentication terminal 200, that is, a control apparatus. The control unit 260 causes the program 221 to be loaded to the memory 230 from the storage unit 220 to execute the loaded program 221. Accordingly, the control unit 260 implements the functions of an image acquisition unit 261, a registration information acquisition unit 262, a settlement unit 263, and an output control unit 264.

The image acquisition unit 261 is also referred to as authentication face information acquisition means. The image acquisition unit 261 controls the camera 210 to cause the camera 210 to capture an image of the face of the user U and generate a face image for authentication including at least a face area of the user U. Then, the image acquisition unit 261 acquires the face image for authentication and the date and time of image capturing from the camera 210.

The image acquisition unit 261 supplies the face image for authentication and the date and time of image capturing to the communication unit 240, and causes the communication unit 240 to transmit the face image for authentication and the date and time of image capturing to the information processing apparatus 300 along with location information of the authentication terminal 200 (a location 1, a location 2, . . . a location i, . . . and a location n).

Further, the image acquisition unit 261 controls the camera 210 to cause the camera 210 to capture an image of the face of the user U and generate a face image for registration including at least the face area of the user U. Then, the image acquisition unit 261 may supply the face image for registration to the communication unit 240 and cause the communication unit 240 to transmit the face image for registration to the information processing apparatus 300.

Note that the face image for registration may be captured by a user terminal (not shown) and transmitted from the user terminal to the information processing apparatus 300. Further, the face image for registration may be captured in the registration terminal installed inside or outside of the amusement facility and transmitted from the registration terminal to the information processing apparatus 300.

The registration information acquisition unit 262 acquires registration information of the user U. The registration information of the user U here includes the name, the address, and the telephone number of the user U, information required to carry out settlement, settlement information, benefit information, etc. Further, the information required to carry out settlement is the number of a card used for settlement, the expiration date thereof, or the like. Further, the settlement information includes, for example, the name of the product or service that the user U has purchased, the price of the product or the service, or the date and time of the purchase. Further, the name of the product that the user U has purchased is, for example, the name of food or drink that the user U has had in the amusement facility. Further, the name of the service that the user U has purchased is, for example, the name of an attraction that the user U has experienced in the amusement facility. Further, the benefit information is earned points, coupons, etc.

The registration information may be input to the authentication terminal 200 by the user U operating an input unit (not shown) of the authentication terminal 200. The registration information acquisition unit 262 may include a card reader, and acquire, for example, registration information of the user U by reading a license or a credit card. Then, the registration information acquisition unit 262 supplies the registration information of the user U to the communication unit 240 to cause the communication unit 240 to transmit the registration information to the information processing apparatus 300.

Note that the registration information may be transmitted from a user terminal (not shown) to the information processing apparatus 300. Further, the registration information may be transmitted from the registration terminal installed inside or outside of the amusement facility to the information processing apparatus 300.

The settlement unit 263 carries out settlement in a case where the face authentication for carrying out settlement in the authentication terminal 200 has been successful. Specifically, the settlement unit 263 acquires information required to carry out settlement by the user U who has been successful in the face authentication from the information processing apparatus 300 and performs settlement. The settlement unit 263 acquires information required to carry out settlement from registration information 312C associated with a user ID 312A received from the information processing apparatus 300 along with the face authentication result. Further, after the settlement is completed, the settlement unit 263 supplies settlement information of this user U to the communication unit 240 and causes the communication unit 240 to transmit the settlement information to the information processing apparatus 300.

The output control unit 264 controls the output unit 250, causes the output unit 250 to output an information processing result to broadcast the information processing result to the user U.

For example, in a case where the output control unit 264 has received an output instruction (described later) from the information processing apparatus 300, the output control unit 264 causes the output unit 250 to output comparison results (described later).

Further, the output control unit 264 causes the output unit 250 to output the result of face authentication to broadcast the result of the face authentication to the user U.

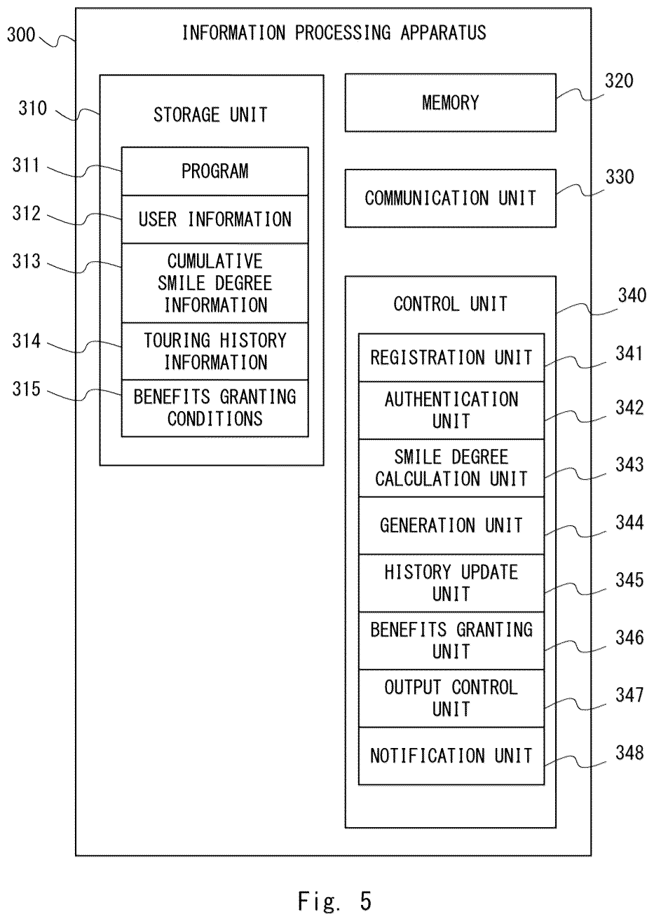

FIG. 5 is a block diagram showing one example of the information processing apparatus 300. As shown in FIG. 5, the information processing apparatus 300 includes a storage unit 310, a memory 320, a communication unit 330, and a control unit 340.

The storage unit 310 is a storage apparatus that stores a program 311 for implementing each function of the information processing apparatus 300. The memory 320, which is a volatile storage apparatus such as a RAM, is a storage area for temporarily holding information at the time of operation of the control unit 340. The communication unit 330 is a communication interface with the network N.

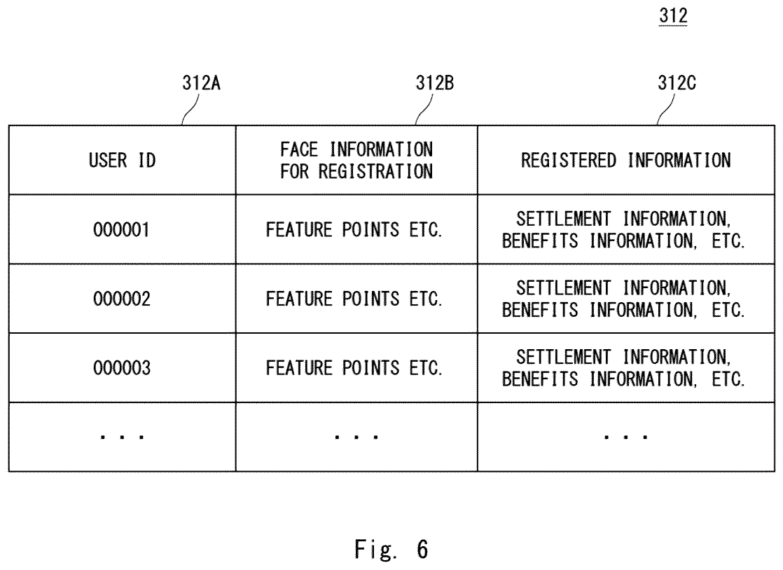

The storage unit 310 stores user information 312. Therefore, the storage unit 310 is also referred to as storage means. FIG. 6 shows one example of the user information 312. As shown in FIG. 6, the user information 312 is information in which a user ID 312A, face information for registration 312B, and registration information 312C are associated with one another. Note that the user information 312 may include management information such as the date and time of image capturing of the face image for registration.

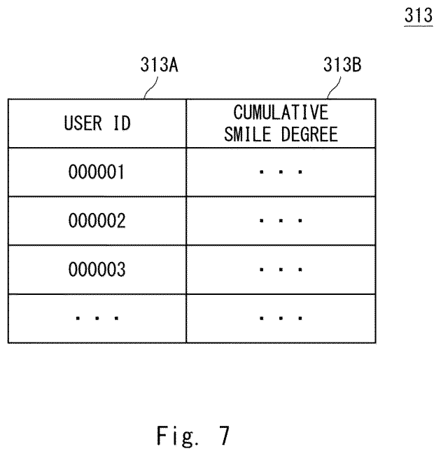

The storage unit 310 stores cumulative smile degree information 313. FIG. 7 shows one example of the cumulative smile degree information 313. As shown in FIG. 7, the cumulative smile degree information 313 is information in which a user ID 313A and a cumulative smile degree 313B are associated with each other.

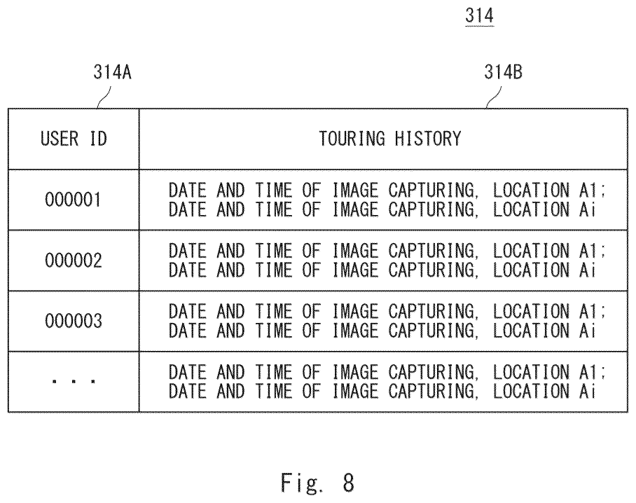

The storage unit 310 stores touring history information 314. FIG. 8 shows one example of the touring history information 314. As shown in FIG. 8, the touring history information 314 is information in which a user ID 314A and touring history 314B are associated with each other. The touring history 314B is a touring history of the user U in the amusement facility. Specifically, the touring history 314B is the date and time when the face image for authentication of the user U has been captured and location information of the authentication terminal 200, both of the information items being received from the authentication terminal 200. Note that the touring history 314B may include, in addition to the date and time when the face image for authentication of the user U has been captured and the location information, the smile degree calculated from the face image for authentication. Accordingly, the storage unit 310 may store the history of the smile degree of the user U as the touring history information 314. Accordingly, a manager of the amusement facility can know in which area of the amusement facility the smile degree is low, in other words, in which area the degree of customer satisfaction is low.

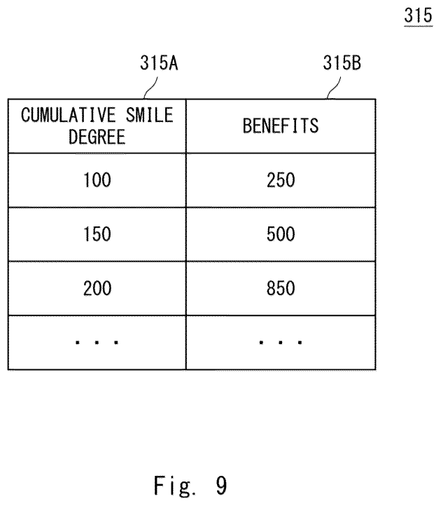

The storage unit 310 stores benefits granting conditions 315. FIG. 9 shows one example of the benefits granting conditions 315. As shown in FIG. 9, the benefits granting conditions 315 are information in which a cumulative smile degree 315A and benefits 315B are associated with each other. Further, the benefits granting conditions 315 may be information in which a touring distance and the benefits are associated with each other.

The control unit 340 is a processor that controls each component of the information processing apparatus 300, that is, a control apparatus. The control unit 340 causes the program 311 to be loaded into the memory 320 from the storage unit 310, thereby executing the program 311. Accordingly, the control unit 340 implements the functions of a registration unit 341, an authentication unit 342, a smile degree calculation unit 343, a generation unit 344, a history update unit 345, a benefits granting unit 346, an output control unit 347, and a notification unit 348.

The registration unit 341 is also referred to as user information registration means. The registration unit 341 registers the user information 312 in the storage unit 310. The registration unit 341 acquires, in a case where it has received face image for registration and registration information from any one of the authentication terminal 200, a user terminal (not shown), or a registration terminal (not shown), the face information for registration 312B from the face image for registration. Next, the registration unit 341 stores the user ID 312A, the face information for registration 312B, and the registration information 312C in the storage unit 310 as the user information 312 in such a way that they are associated with one another. As one example, the face information may be a set of feature points extracted from the face image. Specifically, the registration unit 341 detects a face area included in the face image for registration, extracts feature points from the detected face area, and sets information on the extracted feature points as the face information for registration 312B.

Further, the registration unit 341 generates a user ID 312A. Note that the user ID 312A may be input to the authentication terminal 200, a user terminal (not shown), or a registration terminal (not shown) by the user U operating an input unit (not shown) of any one of the authentication terminal 200, the user terminal (not shown), or the registration terminal (not shown). Then the user ID 312A may be transmitted to the information processing apparatus 300 from any one of the authentication terminal 200, the user terminal (not shown), or the registration terminal (not shown) along with the face image for registration and the registration information. Further, a password, along with the user ID 312A, may be transmitted to the information processing apparatus 300 from one of the authentication terminal 200, the user terminal (not shown), or the registration terminal (not shown). In other words, the registration unit 341 may store the user ID 312A, the password, the face information for registration 312B, and the registration information 312C in the storage unit 310 as the user information 312 in such a way that they are associated with one another. Further, in a case where management information such as the date and time of image capturing of the face image for registration has been transmitted from any one of the authentication terminal 200, the user terminal (not shown), and the registration terminal (not shown), the registration unit 341 may store the user ID 312A, the face information for registration 312B, the registration information 312C, and the management information in the storage unit 310 as the user information 312 in such a way that they are associated with one another.

The authentication unit 342 is also referred to as authentication means. The authentication unit 342 performs face authentication in a case where it has received a face image for authentication from the authentication terminal 200. Then, the authentication unit 342 acquires face information for authentication from the face image for authentication transmitted from the authentication terminal 200, and compares the face information for registration 312B with the face information for authentication, to thereby perform face authentication. Since a method for acquiring the face information for authentication from the face image for authentication is similar to the method for acquiring the face information for registration 312B from the face image for registration in the registration unit 341, the descriptions thereof will be omitted. Further, in a case where the face information for authentication matches the face information for registration 312B, the authentication unit 342 acquires a user ID 312A associated with this face information for registration 312B by referring to the user information 312. The authentication unit 342 then supplies information indicating whether or not the face information items match each other and the user ID 312A to the notification unit 348. Further, in a case where the face information for authentication matches the face information for registration 312B, the authentication unit 342 supplies the face information for authentication to the smile degree calculation unit 343. The information indicating whether or not the face information items match each other corresponds to information indicating whether or not the authentication has been successful. Note that the face information items matching each other (match: yes) means that the degree of match being equal to or greater than a predetermined value.

Note that the face authentication processing may be performed in another apparatus, such as the authentication terminal 200. In this case, the authentication unit 342 may control face authentication processing performed in the other apparatus.

The smile degree calculation unit 343 is also referred to as smile degree calculation means. In a case where the face authentication has been successful, the smile degree calculation unit 343 calculates a smile degree of the user U from the face information for authentication. The calculated smile degree is supplied to the generation unit 344. Further, the calculated smile degree may be supplied to the history update unit 345. Here, a specific example for calculating the smile degree of the user U will be described. In general, when a person smiles, some facial features appear in a face area; for example, the corners of the mouth rise, the corners of the eyes fall, the eyes become narrower, and wrinkles appear around the mouth. Therefore, the smile degree calculation unit 343 may extract feature points of facial organs such as both eyes and the mouth in the face area of the user U and calculate a smile degree based on coordinates of each of the feature points that have been extracted. Further, the smile degree calculation unit 343 may calculate the smile degree using an identifier after learning. The identifier may be a support vector machine (SVM) that receives feature amounts of facial organs and outputs a result indicating whether or not the smile degree is equal to or greater than a predetermined smile degree. Further, the identifier may be a convolutional neural network (CNN) that receives a face area of the captured image and outputs a smile degree. Note that the method for calculating the smile degree is not limited to the above-described one and any existing method may be used instead.

Further, in a case where the captured image includes a face area of the user U and that of a person who is with the user U, the smile degree calculation unit 343 may calculate the smile degree based on, besides the smile degree of the face area of the user U, a smile degree of the face area of the person who is with the user U. The smile degree calculation unit 343 may calculate, for example, an average value of the smile degree of the face area of the user U and the smile degree of the face area of the person who is with the user U as a smile degree.

The generation unit 344 is also referred to as cumulative smile degree generation means. The generation unit 344 accumulates smile degrees of the user U calculated from the face information for authentication acquired in each of a plurality of locations A1, A2,. . . Ai, . . . and An in a facility to generate a cumulative smile degree. Specifically, the generation unit 344 adds the calculated smile degree to the cumulative smile degree 313B associated with the user ID 313A of the user U of the cumulative smile degree information 313 shown in FIG. 7 to thereby generate a new cumulative smile degree. Further, the generation unit 344 associates this user ID 313A with the generated cumulative smile degree 313B to store this associated information in the storage unit 310 as the cumulative smile degree information 313. Further, the generated cumulative smile degree is supplied to the benefits granting unit 346 and the output control unit 347.

The history update unit 345 is also referred to as history information update means.

In a case where the face authentication has been successful, the history update unit 345 updates touring history information 314 of the user U who has been successful in the face authentication. Specifically, the history update unit 345 adds the date and time of image capturing of the face image for authentication and location information of the authentication terminal 200 (a location 1, a location 2, . . . a location i, . . . and a location n) received from the authentication terminal 200 along with the face image for authentication to the touring history 314B of the touring history information 314 shown in FIG. 8.

Further, the history update unit 345 may add the smile degree received from the smile degree calculation unit 343 to the touring history 314B of the touring history information 314 along with the date and time when the face image for authentication of the user U has been captured and the location information.

The benefits granting unit 346 is also referred to as benefits granting means. The benefits granting unit 346 grants benefits in accordance with the cumulative smile degree to the user U. Specifically, the benefits granting unit 346 gives the benefits 315B that correspond to the cumulative smile degree 315A received from the generation unit 344 to the user U from the benefits granting conditions 315 shown in FIG. 9. More specifically, the benefits granting unit 346 adds the benefits 315B to benefits included in the registration information 312C of the user U of the user information 312. Note that the benefits granting unit 346 may transmit the benefits 315B to a user terminal (not shown) of the user U. Further, the benefits granting unit 346 may grant benefits in accordance with the touring history to the user U. For example, the benefits granting unit 346 may refer to the touring history 314B that corresponds to the user ID 314A of the user U, acquire the touring distance of the user U, and grant benefits of the user U in accordance with the touring distance. Note that the touring distance may be a total of the distances between locations (a location 1, a location 2, . . . a location i, . . . and a location n) that the user U has stopped by, the locations being included in the touring history 314B.

The output control unit 347 is also called output control means. In a case where the face authentication has been successful, the output control unit 347 causes the authentication terminal 200 to output results of comparing the cumulative smile degree 313B of the user U with the cumulative smile degree 313B of another user. Specifically, the output control unit 347 generates results of comparing the cumulative smile degree 313B of the user U with the cumulative smile degree 313B of another user by referring to the cumulative smile degree information 313 shown in FIG. 7. Then, the output control unit 347 causes the communication unit 330 to transmit an output instruction including the generated comparison results to the authentication terminal 200.

Further, the output control unit 347 may cause the authentication terminal 200 to further output results of comparing the touring history 314B of the user U with the touring history 314B of another user. Specifically, the output control unit 347 generates results of comparing the touring distance of the user U with the touring distance of another user by referring to the touring history information 314 shown in FIG. 8. Then, the output control unit 347 causes the communication unit 330 to transmit an output instruction including the generated comparison results to the authentication terminal 200.

In a case where the face authentication result indicates face information match: yes, that is, face authentication has been successful, the notification unit 348 notifies the authentication terminal 200 of the face authentication result and the user ID 312A. Note that the user ID 312A may be included in the face authentication result.

Further, the notification unit 348 may transmit information indicating that the face authentication has failed to the authentication terminal 200 as an error notification. Note that the notification unit 348 may cause the user ID 312A to be included in the error notification. However, this is merely an example.

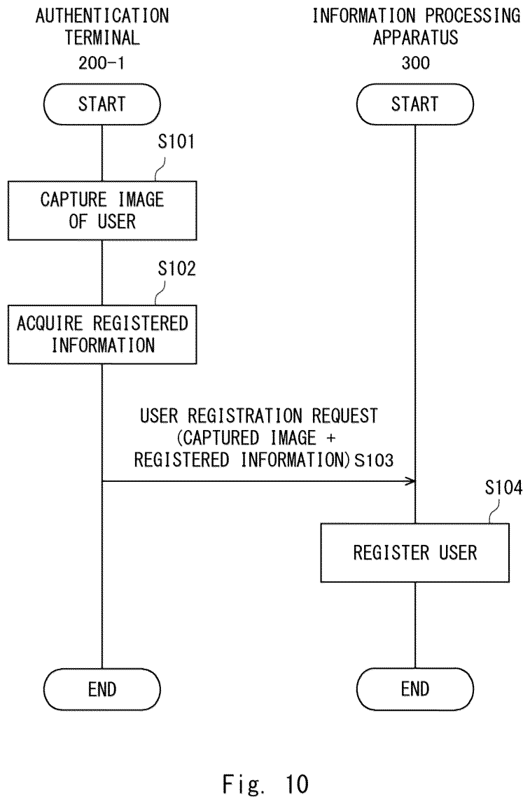

FIG. 10 is a flowchart showing one example of processing for registering the user information in the authentication method according to the second example embodiment. In the following flowchart, an explanation will be given of a case where a face image for registration of the user U and registration information are acquired in the authentication terminal 200-1 installed in the first location Al, among authentication terminals 200-1, 200-2, . . . 200-i, . . . and 200-n installed in a plurality of respective locations A1, A2, . . . Ai, . . . and An of an amusement facility, as an example. The first location Al here is, for example, a location of the authentication terminal 200-1 installed at or near a gate of the amusement facility. However, the face image for registration of the user U and the registration information may be acquired in a user terminal (not shown) of the user U or a registration terminal installed inside or outside of the amusement facility and transmitted to the information processing apparatus 300.

First, the image acquisition unit 261 of the authentication terminal 200-1 causes the camera 210 to capture an image of the face of the user U to acquire the face image for registration (Step S101). Next, the registration information acquisition unit 262 of the authentication terminal 200-1 acquires registration information on the user U (Step S102). Next, the communication unit 240 transmits the face image for registration and the registration information to the information processing apparatus 300 and requests user registration (Step S103). Next, the registration unit 341 of the information processing apparatus 300 performs user registration (Step S104), and this process is ended. Specifically, the registration unit 341 generates face information for registration 312B from the face image for registration. The registration unit 341 further generates a user ID 312A. Then, the registration unit 341 stores the user ID 312A, the face information for registration 312B, and the registration information 312C in the storage unit 310 as the user information 312 in such a way that they are associated with one another.

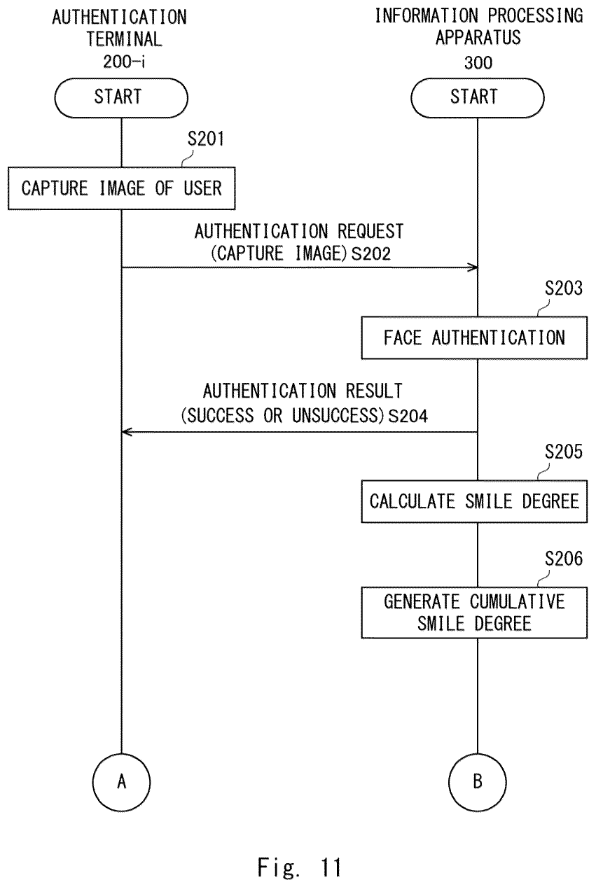

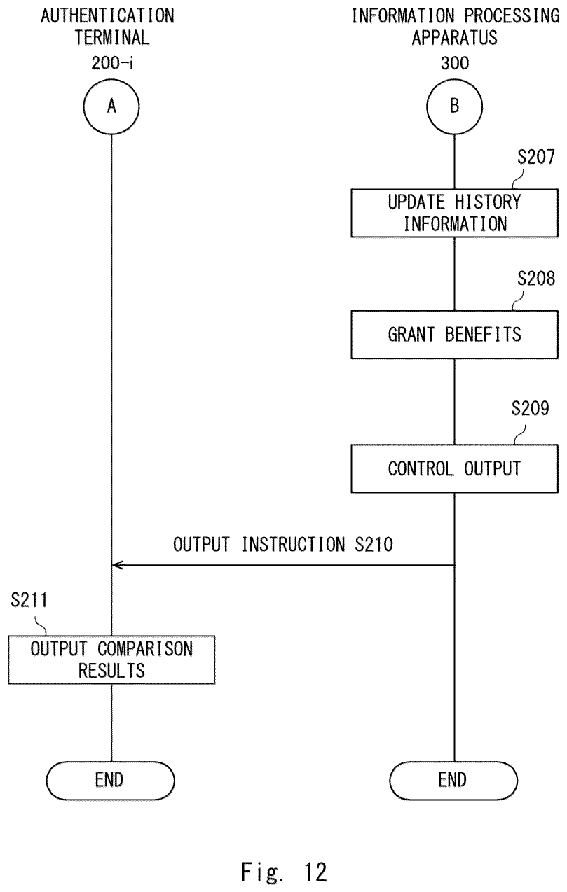

FIGS. 11 and 12 are each a flowchart showing an authentication method according to the second example embodiment. The authentication method shown in FIGS. 11 and 12 is performed after the processing for registering the user information shown in FIG. 10 is performed. First, the image acquisition unit 261 of the authentication terminal 200-i causes the camera 210 to capture an image of the face of the user U, to thereby acquire the face image for authentication (Step S201). Next, the communication unit 240 transmits the face image for authentication, the date and time of image capturing, and the location information to the information processing apparatus 300, and requests for authentication (Step S202). Next, the authentication unit 342 of the information processing apparatus 300 performs face authentication (Step S203). Specifically, the authentication unit 342 generates face information for authentication from the face image for authentication, compares the face information for authentication with face information for registration 312B of the user information 312, and determines, when the degree of match of these face information items is equal to or greater than a predetermined value, that the face authentication has been successful. Next, the notification unit 348 notifies the authentication terminal 200-i of an authentication result indicating whether or not the face authentication has been successful and the user ID 312A (Step S204). Next, in a case where the face authentication has been successful, the smile degree calculation unit 343 calculates the smile degree of the user U from the face information for authentication (Step S205). Between Step S204 and Step S205, the output control unit 264 of the authentication terminal 200-i may cause the output unit 250 to display or output, by voice, a result of the face authentication to broadcast the result of the face authentication to the user U. Next, in a case where the face authentication has been successful, the generation unit 344 accumulates smile degrees of the user U to generate a cumulative smile degree (Step S206). Specifically, the generation unit 344 adds the smile degree calculated in Step S205 to the cumulative smile degree 313B associated with the user ID 313A of the user U of the cumulative smile degree information 313. Next, in a case where the face authentication has been successful, the history update unit 345 updates the touring history information 314 of the user U who has been successful in the face authentication (Step S207). Next, the benefits granting unit 346 grants benefits in accordance with the cumulative smile degree 313B of the user U and the touring history 314B to the user U (Step S208). Next, the output control unit 347 of the information processing apparatus 300 controls output of the output unit 250 of the authentication terminal 200-i (Step S209). Specifically, the output control unit 347 generates results of comparing (ranking) the cumulative smile degree 313B of the user U and the touring history 314B with the cumulative smile degree 313B of another user and the touring history 314B. Next, the communication unit 330 transmits an output instruction including the comparison results to the authentication terminal 200 (Step S210). Next, the output control unit 264 of the authentication terminal 200-i causes the output unit 250 to output the comparison results (Step S211), and this process is ended.

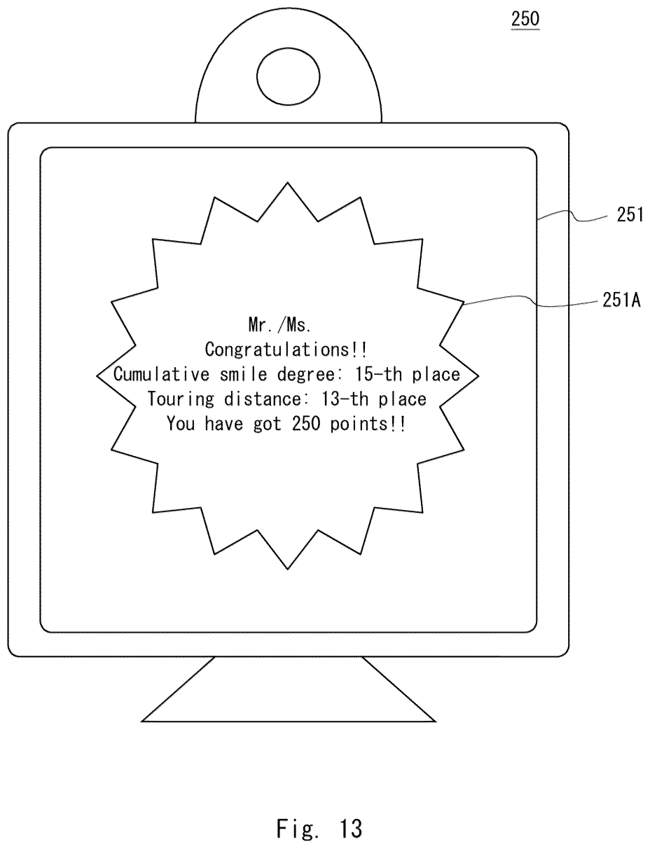

FIG. 13 shows one example of the output unit 250 of the authentication terminal 200 that displays the comparison results. As shown in FIG. 13, the display unit 251 of the output unit 250 displays a message 251A including the comparison results and benefits earned by the user U. As shown in FIG. 13, the message 251A includes, as the comparison results, a ranking of the cumulative smile degree “Cumulative smile degree: 15-th place” and a ranking of the touring history “Touring distance: 13-th place”. Further, the message 251A includes “You have got 250 points!!” as benefits earned by the user U. Note that the voice output unit 252 of the output unit 250 may output this message by voice.

With the authentication system 100 according to the second example embodiment described above, the smile degree of the user U in each location is calculated from the face information for authentication received from the authentication terminals 200-1, 200-2, . . . 200-i, . . . and 200-n installed in the plurality of respective locations A1, A2, . . . Ai, . . . and An of the amusement facility, and a cumulative smile degree 313B in which the calculated smile degrees are accumulated is generated. Then, the authentication terminal 200 is caused to output the results (ranking) of comparing the cumulative smile degree 313B of the user U with the cumulative smile degree 313B of another user. Therefore, compared to the case where a smile degree is determined only at a final location in the amusement facility, the amusement facility can be made even more attractive using the face authentication technique.

Further, in the authentication system 100 according to the second example embodiment, the authentication terminal 200 is further caused to output results of comparing the touring history 314B of the user U with the touring history 314B of another user. Therefore, the amusement facility can be made even more attractive using the face authentication technique.

Further, with the authentication system 100 according to the second example embodiment, the smile degree of the user U is added and the touring history information is updated. Specifically, the touring history 314B of the touring history information 314 includes, besides the date and time when the face image for authentication of the user U has been captured and the location information, the smile degree calculated from the face image for authentication. A manager of the amusement facility is able to know, by referring to the touring history information 314, in which area of the amusement facility the smile degree is low, in other words, in which area the degree of customer satisfaction is low.

Further, in the authentication system 100 according to the second example embodiment, benefits in accordance with the cumulative smile degree 313B are granted to the user U. Therefore, amusement facilities can be made even more attractive.

Further, in the authentication system 100 according to the second example embodiment, benefits in accordance with the touring history 314B are granted to the user U. Therefore, amusement facilities can be made even more attractive.

In the aforementioned example embodiments, the present invention has been described as a hardware configuration. However, this is merely an example. The present disclosure may implement desired processing by causing a processor to execute a computer program.

In the above-described examples, the program can be stored and provided to a computer using any type of non-transitory computer readable media. Non-transitory computer readable media include any type of tangible storage media.

Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, DVD (Digital Versatile Disc), and semiconductor memories (e.g., mask ROM, PROM (Programmable ROM), EPROM (Erasable PROM), flash ROM, and RAM (Random Access Memory), etc.) The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present application has been described above with reference to the example embodiments, the present application is not limited to the above-described example embodiments. Various changes that can be understood by those skilled in the art within the scope of the present application can be made to the configurations and the details of the present application.

The whole or part of the example embodiments disclosed above can be described as, but not limited to, the following supplementary notes.

### (Supplementary Note 1)

An information processing apparatus comprising:
authentication means for controlling face authentication by comparing face information for authentication of a user acquired in each of a plurality of locations in a facility with face information for registration registered in advance;
smile degree calculation means for calculating a smile degree of the user from the face information for authentication;
cumulative smile degree generation means for accumulating the smile degrees of the user calculated from the face information for authentication acquired in the plurality of respective locations in the facility to generate a cumulative smile degree; and
output control means for controlling output of a result of comparing the cumulative smile degree of the user and that of another user.

### (Supplementary Note 2)

The information processing apparatus according to Supplementary Note 1, further comprising history information update means for updating touring history information regarding a touring history of the user in the facility,
wherein the output control means further controls output of a result of comparing the touring history of the user with that of another user.

### (Supplementary Note 3)

The information processing apparatus according to Supplementary Note 2, wherein the history information update means adds the smile degree of the user and then updates the touring history information.

### (Supplementary Note 4)

The information processing apparatus according to Supplementary Note 1, further comprising benefits granting means for granting benefits in accordance with the cumulative smile degree to the user.

### (Supplementary Note 5)

The information processing apparatus according to Supplementary Note 2, further comprising benefits granting means for granting benefits in accordance with the touring history to the user.

### (Supplementary Note 6)

An authentication system comprising:
authentication terminals installed in a plurality of locations in a facility; and
an information processing apparatus capable of communicating with the authentication terminals, wherein
the information processing apparatus comprises user information registration means for registering face information for registration of a user in storage means,
the authentication terminal comprises authentication face information acquisition means for acquiring face information for authentication of the user, and
the information processing apparatus further comprises:
   authentication means for performing face authentication by comparing face information for authentication of the user acquired in each of the plurality of locations in the facility with the face information for registration;
   smile degree calculation means for calculating, in a case where the face authentication has been successful, a smile degree of the user from the face information for authentication;
   cumulative smile degree generation means for accumulating the smile degrees of the user calculated from the face information for authentication acquired in the plurality of respective locations in the facility to generate a cumulative smile degree; and
   output control means for causing the authentication terminal to output a result of comparing the cumulative smile degree of the user with that of another user.

### (Supplementary Note 7)

The authentication system according to Supplementary Note 6, wherein
the information processing apparatus further comprises history information update means for updating touring history information regarding a touring history of the user in the facility, and
the output control means causes the authentication terminal to output a result of comparing the touring history of the user with that of another user.

### (Supplementary Note 8)

The authentication system according to Supplementary Note 7, wherein the history information update means adds the smile degree of the user and then updates the touring history information.

### (Supplementary Note 9)

The authentication system according to Supplementary Note 6, wherein the information processing apparatus further comprises benefits granting means for granting benefits in accordance with the cumulative smile degree to the user.

### (Supplementary Note 10)

The authentication system according to Supplementary Note 7, wherein the information processing apparatus further comprises benefits granting means for granting benefits in accordance with the touring history to the user.

### (Supplementary Note 11)

An authentication method, wherein a computer:
controls face authentication by comparing face information for authentication of a user acquired in each of a plurality of locations in a facility with face information for registration registered in advance;
calculates a smile degree of the user from the face information for authentication;
accumulates the smile degrees of the user calculated from the face information for authentication acquired in the plurality of respective locations in the facility to generate a cumulative smile degree; and
controls output of a result of comparing the cumulative smile degree of the user with that of another user.

### (Supplementary Note 12)

The authentication method according to Supplementary Note 11, wherein the computer:
updates touring history information regarding a touring history of the user in the facility, and
further controls output of a result of comparing the touring history of the user with that of another user.

### (Supplementary Note 13)

The authentication method according to Supplementary Note 12, wherein the computer adds the smile degree of the user and then updates the touring history information.

### (Supplementary Note 14)

The authentication method according to Supplementary Note 11, wherein the computer grants benefits in accordance with the cumulative smile degree to the user.

### (Supplementary Note 15)

The authentication method according to Supplementary Note 12, wherein the computer grants benefits in accordance with the touring history to the user.

### (Supplementary Note 16)

A non-transitory computer readable medium storing a program for causing a computer to perform:
processing for controlling face authentication by comparing face information for authentication of a user acquired in each of a plurality of locations in a facility with face information for registration registered in advance;
processing for calculating a smile degree of the user from the face information for authentication;
processing for accumulating the smile degrees of the user calculated from the face information for authentication acquired in the plurality of respective locations in the facility to generate a cumulative smile degree; and
processing for controlling output of a result of comparing the cumulative smile degree of the user with that of another user.

### (Supplementary Note 17)

The non-transitory computer readable medium according to Supplementary Note 16, the non-transitory computer readable medium storing a program for causing the computer to execute:
processing for updating touring history information regarding a touring history of the user in the facility; and
processing for further controlling output of a result of comparing the touring history of the user with that of another user.

### (Supplementary Note 18)

The non-transitory computer readable medium according to Supplementary Note 17, the non-transitory computer readable medium storing a program for causing the computer to execute processing for adding the smile degree of the user and updating the touring history information.

### (Supplementary Note 19)

The non-transitory computer readable medium according to Supplementary Note 16, the non-transitory computer readable medium storing a program for causing the computer to execute processing for granting benefits in accordance with the cumulative smile degree to the user.

### (Supplementary Note 20)

The non-transitory computer readable medium according to Supplementary Note 17, the non-transitory computer readable medium storing a program for causing the computer to execute processing for granting benefits in accordance with the touring history to the user.

### REFERENCE SIGNS LIST

10,300 Information Processing Apparatus
100 Authentication System
200 Authentication Terminal
11 Storage Unit (Storage Means)
310 Storage Unit (Storage Means)
12,341 Registration Unit (User Information Registration Means)
13,342 Authentication Unit (Authentication Means)
14,343 Smile Degree Calculation Unit (Smile Degree Calculation Means)
15,344 Generation Unit (Cumulative Smile Degree Generation Means)
16,347 Output Control Unit (Output Control Means)
345 History Update Unit (History Information Update Means)
346 Benefits Granting Unit (Benefits Granting Means)
261 Image Acquisition Unit (Authentication Face Information Acquisition Means)

What is claimed is:

1. An information processing apparatus comprising:
a memory storing instructions; and
one or more processors configured to execute the instructions to:
control face authentication by comparing face information for authentication of a user acquired in each of a plurality of locations in a facility with face information for registration registered in advance;
calculate a smile degree of the user from the face information for authentication;
accumulate the smile degrees of the user calculated from the face information for authentication acquired in the plurality of respective locations in the facility to generate a cumulative smile degree; and
control output of a result of comparing the cumulative smile degree of the user and that of another user.

2. The information processing apparatus according to claim 1, the one or more processors configured to execute the instructions to:
update touring history information regarding a touring history of the user in the facility,
wherein the one or more processors further controls output of a result of comparing the touring history of the user with that of another user.

3. The information processing apparatus according to claim 2, wherein the one or more processors adds the smile degree of the user and then updates the touring history information.

4. The information processing apparatus according to claim 1, the one or more processors configured to execute the instructions to:
grant benefits in accordance with the cumulative smile degree to the user.

5. The information processing apparatus according to claim 2, the one or more processors configured to execute the instructions to:
grant benefits in accordance with the touring history to the user.

6-10. (canceled)

11. An authentication method, wherein a computer:
controls face authentication by comparing face information for authentication of a user acquired in each of a plurality of locations in a facility with face information for registration registered in advance;
calculates a smile degree of the user from the face information for authentication;
accumulates the smile degrees of the user calculated from the face information for authentication acquired in the plurality of respective locations in the facility to generate a cumulative smile degree; and
controls output of a result of comparing the cumulative smile degree of the user with that of another user.

12. The authentication method according to claim 11, wherein the computer:
updates touring history information regarding a touring history of the user in the facility, and
further controls output of a result of comparing the touring history of the user with that of another user.

13. The authentication method according to claim 12, wherein the computer adds the smile degree of the user and then updates the touring history information.

14. The authentication method according to claim 11, wherein the computer grants benefits in accordance with the cumulative smile degree to the user.

15. The authentication method according to claim 12, wherein the computer grants benefits in accordance with the touring history to the user.

16. A non-transitory computer readable medium storing a program for causing a computer to perform:
processing for controlling face authentication by comparing face information for authentication of a user acquired in each of a plurality of locations in a facility with face information for registration registered in advance;
processing for calculating a smile degree of the user from the face information for authentication;
processing for accumulating the smile degrees of the user calculated from the face information for authentication acquired in the plurality of respective locations in the facility to generate a cumulative smile degree; and
processing for controlling output of a result of comparing the cumulative smile degree of the user with that of another user.

17. The non-transitory computer readable medium according to claim 16, the non-transitory computer readable medium storing a program for causing the computer to execute:
processing for updating touring history information regarding a touring history of the user in the facility; and
processing for further controlling output of a result of comparing the touring history of the user with that of another user.

18. The non-transitory computer readable medium according to claim 17, the non-transitory computer readable medium storing a program for causing the computer to execute processing for adding the smile degree of the user and updating the touring history information.

19. The non-transitory computer readable medium according to claim 16, the non-transitory computer readable medium storing a program for causing the computer to execute processing for granting benefits in accordance with the cumulative smile degree to the user.

20. The non-transitory computer readable medium according to claim 17, the non-transitory computer readable medium storing a program for causing the computer to execute processing for granting benefits in accordance with the touring history to the user.
